(19) United States
(12) Patent Application Publication
(10) Pub. No.: US 2020/0001524 A1
(43) Pub. Date: Jan. 2, 2020

(54) SYSTEM AND METHOD FOR MANUFACTURING A THREE-DIMENSIONAL OBJECT

(71) Applicant: Schultheiss GmbH, Heimsheim (DE)

(72) Inventors: Andreas Schultheiss, Muehlacker (DE); Andreas Geitner, Leonberg (DE)

(21) Appl. No.: 16/511,039

(22) Filed: Jul. 15, 2019

Related U.S. Application Data
(63) Continuation of application No. PCT/EP2018/051072, filed on Jan. 17, 2018.

(30) Foreign Application Priority Data
Jan. 17, 2017 (DE) 10 2017 100 851.9
Mar. 30, 2017 (DE) 10 2017 106 874.0

(51) Int. Cl. B29C 64/124; B29C 64/245; B29C 64/264; B29C 64/232; B29C 64/255

(52) U.S. Cl. CPC B29C 64/124; B29C 64/245; B33Y 10/00; B29C 64/232; B29C 64/255; B29C 64/264

(57) ABSTRACT

The invention relates to a system for manufacturing a three-dimensional object by solidifying, in particular in layers or continuously, a material that is solidifiable under the action of radiation, wherein the system includes a device for manufacturing a three-dimensional object by solidifying, in particular in layers or continuously, a material that is solidifiable under the action of radiation, wherein the system includes a carrier arrangement for holding the three-dimensional object that has been solidified from the solidifiable material, wherein on the one hand at least one of the carrier arrangement and a part thereof, and on the other the device, are formed such that they are detachably connectable to one another, in particular for the purpose of separation once the solidified three-dimensional object has been formed.

### CROSS-REFERENCE TO RELATED APPLICATIONS

This application is a continuation of international application number PCT/EP2018/051072 filed on Jan. 17, 2018 and claims the benefit of German applications number 10 2017 100 851.9 filed on Jan. 17, 2017 and 10 2017 106 874.0 filed on Mar. 30, 2017, which are incorporated herein by reference in their entirety and for all purposes.

### FIELD OF THE INVENTION

The present invention relates to a system for manufacturing a three-dimensional object by solidifying, in particular in layers or continuously, a material that is solidifiable under the action of radiation, wherein the system includes a device for manufacturing a three-dimensional object by solidifying, in particular in layers or continuously, a material that is solidifiable under the action of radiation, wherein the system includes a carrier arrangement for holding the three-dimensional object that has been solidified from the solidifiable material.

Further, the present invention relates to a method for manufacturing a three-dimensional object by solidifying, in particular in layers or continuously, a material that is solidifiable under the action of radiation, wherein in the method the three-dimensional object that has been solidified from the solidifiable material is held on a carrier arrangement, wherein the solidified three-dimensional object is post-solidified for the purpose of curing it, in particular by applying electromagnetic radiation thereto.

### BACKGROUND OF THE INVENTION

Numerous variants of systems and methods of the type mentioned in the introduction have been developed in recent years. They are available as so-called 3D printers, and serve for manufacturing the most diverse three-dimensional objects, in particular from plastics materials.

When the three-dimensional objects are manufactured by solidifying the solidifiable material in layers or continuously under the action of radiation, the solidifiable material is not always solidified in a sufficiently permanent manner, and for this reason post-solidification, in particular by post-exposure, is typically required. If the solidifiable material used is a liquid, polymerisable plastics material, it is possible in particular for regions in the interior of the object not to be sufficiently polymerised. For this reason, post-polymerisation is almost always required.

One problem during post-solidification of the three-dimensional object, in particular by irradiation, is possible deformation thereof. This is in particular undesirable, in particular in the case of objects in which it is imperative to make external dimensions with a high degree of precision.

### SUMMARY OF THE INVENTION

In a first aspect of the invention, a system for manufacturing a three-dimensional object by solidifying, in particular in layers or continuously, a material that is solidifiable under the action of radiation is provided. The system includes a device for manufacturing a three-dimensional object by solidifying, in particular in layers or continuously, a material that is solidifiable under the action of radiation. The system includes a carrier arrangement for holding the three-dimensional object that has been solidified from the solidifiable material. On the one hand at least one of the carrier arrangement and a part thereof, and on the other the device, are formed such that they are detachably connectable to one another, in particular for the purpose of separation once the solidified three-dimensional object has been formed.

In a second aspect of the invention, a method for manufacturing a three-dimensional object by solidifying, in particular in layers or continuously, a material that is solidifiable under the action of radiation is provided. The three-dimensional object that has been solidified from the solidifiable material is held on a carrier arrangement. The solidified three-dimensional object is post-solidified for the purpose of curing it, in particular by applying electromagnetic radiation thereto. During post-solidification the solidified three-dimensional object is held by at least one of the carrier arrangement and a part thereof.

### BRIEF DESCRIPTION OF THE DRAWING FIGURES

The foregoing summary and the following description may be better understood in conjunction with the drawing figures, of which:

FIG. 1 shows a schematic illustration of a system for manufacturing a three-dimensional object;

FIG. 2 shows a schematic perspective illustration of part of the system for manufacturing a three-dimensional object;

FIG. 3 shows a schematic sectional view of an exemplary embodiment of a carrier arrangement of a system for manufacturing a three-dimensional object;

FIG. 4 shows a view similar to FIG. 3, of a second exemplary embodiment of a carrier arrangement;

FIG. 5 shows a schematic sectional view of a further exemplary embodiment of a carrier element;

FIG. 6 shows a sectional view of a further exemplary embodiment of a carrier element;

FIG. 7 shows a sectional view of a further exemplary embodiment of a carrier element;

FIG. 8 shows a sectional view of a further exemplary embodiment of a carrier element;

FIG. 9 shows a sectional view of a further exemplary embodiment of a carrier element;

FIG. 10 shows a plan view of a carrier arrangement with a base body and two carrier elements, with solidified three-dimensional objects thereon; and

FIG. 11 shows a schematic perspective illustration of a post-solidifying device having, arranged therein, two carrier elements with three-dimensional objects, during post-solidification.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a system for manufacturing a three-dimensional object by solidifying, in particular in layers or continuously, a material that is solidifiable under the action of radiation, wherein the system includes a device for manufacturing a three-dimensional object by solidifying, in particular in layers or continuously, a material that is solidifiable under the action of radiation, wherein the system includes a carrier arrangement for holding the three-dimensional object that has been solidified from the solidifiable material, wherein on the one hand at least one of the carrier arrangement and a part thereof, and on the other the device, are formed such that they are detachably connectable to one another, in particular for the purpose of separation once the solidified three-dimensional object has been formed.

Developing a system of the type mentioned in the introduction in the proposed manner makes it possible in particular to detach the carrier arrangement and/or a part thereof from the device when the three-dimensional object has been solidified. For the purpose of post-solidification, for example by post-exposure, the three-dimensional object may however remain on the carrier arrangement and/or a part thereof. As a result, the three-dimensional object is held and supported in a defined manner during post-solidification by post-exposure or post-polymerisation and, by comparison with previous procedures, cannot therefore deform, or only to a negligible extent. In this way, three-dimensional objects can be manufactured with markedly improved precision, in particular with highly precise dimensions. In particular in dental technology, in this way it is possible to manufacture individual teeth, bridges or impressions highly precisely, for example from 3D data of a patient, which can be provided using appropriate imaging methods.

It is advantageous if the carrier arrangement includes a carrier base body and at least one carrier element, and the carrier base body and the at least one carrier element are formed such that they are detachably connectable to one another. This development makes it possible in particular to detach the solidified three-dimensional object, together with the at least one carrier element on which it is held, from the carrier base body and to leave it on the at least one carrier element for post-solidification. Thus, post-solidification of the three-dimensional object may be achieved with dimensional stability. Deformation of the three-dimensional object during post-solidification can thus only occur to a limited extent or not at all.

The system may be formed particularly compactly if the at least one carrier element forms part of the carrier base body. For example, there may be provided on the carrier base body a carrier element recess that is entirely or partly filled by the at least one carrier element in a connected position.

It is advantageous if the carrier arrangement defines a carrier surface on which the solidified three-dimensional object is held. The carrier surface may in particular be subdivided into a plurality of surface regions that are delimited by a plurality of carrier elements.

Preferably, the carrier base body and/or the at least one carrier element define the carrier surface. In particular, the carrier arrangement may take a form such that it can carry a plurality of three-dimensional objects and each three-dimensional object is manufactured and held on a separate carrier element.

Depending on the shape of the three-dimensional object to be manufactured, it may be advantageous if the carrier surface takes a form that is planar or, facing away from the carrier arrangement, is curved concavely or convexly or takes a structured form. Structuring may in particular be a macroscopic structuring that has grooves or recesses or apertures. For example, the carrier surface may take a corrugated or perforated form.

Preferably, the carrier surface has at least one recess or aperture. In particular, a plurality of recesses or apertures that are arranged or formed distributed over the carrier surface regularly, in particular symmetrically, or irregularly, in particular stochastically, may also be provided.

Structuring of the carrier surface may be formed in a simple manner if the at least one recess takes the form of a groove or a hole or an indentation. Holes may in particular be formed as bored holes in a simple manner. Indentations may in particular be made in the form of blind holes in a simple manner. Grooves may be formed in particular as rectangular or trapezoidal in cross section.

A particularly compact form of the system can be achieved if the device includes the carrier arrangement.

The at least one carrier element can be used multiple times in a simple and reliable manner if the system includes a coupling arrangement for temporarily coupling the carrier base body and the at least one carrier element in a coupled position. In this way, three-dimensional objects may be manufactured by solidification in the coupled position. For the purpose of post-solidification, it is then possible for example to detach the at least one carrier element from the carrier base body such that they are completely separated from one another and define a separated position.

A coupling arrangement may be formed in a simple manner if it includes at least one first coupling element and at least one second coupling element, of which one is formed or arranged on the carrier base body and the other on the at least one carrier element, and in the coupled position engage with force locking and/or positive locking or by substance-to-substance bond. In particular, the carrier base body and the at least one carrier element may be held against one another in the coupled position magnetically or by negative pressure.

It is further advantageous if the at least one first coupling element and the at least one second coupling element are disengaged in an uncoupled position in which the carrier base body and the at least one carrier element are completely separated from one another. Thus, the carrier base body and the at least one carrier element can be separated from one another in a simple manner, in particular for post-solidification of the three-dimensional object that is held on the at least one carrier element and for cleaning the at least one carrier element and using it multiple times.

The coupling arrangement can be formed in a particularly simple manner if the at least one first coupling element takes the form of a coupling receiver and the at least one second coupling element takes the form of a coupling projection that corresponds to the coupling receiver. For example, in the coupled position the coupling projection and the coupling receiver may engage with one another by clamping or latching.

For the purpose of manufacturing the three-dimensional object, it is advantageous if the system includes a container for the solidifiable material, wherein the carrier arrangement and the container are formed or arranged movable relative to one another. In this way, the three-dimensional object may be formed in layers or continuously by irradiating the solidifiable material in the container.

The carrier arrangement and the container may be moved relative to one another in a simple manner if the system includes a lifting arrangement for moving the carrier arrangement relative to a radiation source and/or to the container. The radiation source may in particular be included within the system for the purpose of generating radiation for solidifying the solidifiable material.

In order where appropriate to be able to detach the entire carrier arrangement from the device, it is favourable if the system includes a coupling arrangement for temporarily coupling the lifting arrangement and the carrier arrangement in a coupled position. In this way, the carrier arrangement can be detached as a whole from the lifting arrangement or connected thereto again.

According to a preferred embodiment, it may be provided for the coupling arrangement to include at least one first coupling element and at least one second coupling element, of which one is formed or arranged on the lifting arrangement and the other on the carrier arrangement, and which in the coupled position engage with force locking and/or positive locking and/or by substance-to-substance bond.

In particular for the purpose of cleaning the system, it is advantageous if the at least one first coupling element and the at least one second coupling element are disengaged in an uncoupled position in which the lifting arrangement and the carrier arrangement are completely separated from one another.

The coupling arrangement can be formed in a particularly simple manner if the at least one first coupling element takes the form of a coupling receiver and the at least one second coupling element takes the form of a coupling projection that corresponds to the coupling receiver.

Preferably, the lifting arrangement is formed for the purpose of raising and lowering the carrier arrangement in relation to the direction of gravity. Thus, in particular the carrier arrangement may be moved relative to the container and parallel to the direction of gravity, for the purpose of manufacturing a three-dimensional object by solidifying the solidifiable material in layers or continuously.

So that structures of the three-dimensional object that is to be manufactured can be solidified in a targeted manner, it is favourable if the system includes an exposing arrangement for the purpose of exposing the solidifiable material by the application of radiation thereto, in particular in layers or continuously. In particular, the exposing arrangement may generate radiation of differing intensity and differing wavelength, or attenuate a radiation source in an appropriate manner. Optionally, mask-type exposures are also possible using the exposing arrangement.

Preferably, the exposing arrangement includes a radiation source. Using this, in particular electromagnetic radiation can be generated in a simple way for the purpose of solidifying the solidifiable material.

So that structures of any desired type and size can be solidified from the solidifiable material in a targeted manner, it is advantageous if the exposing arrangement includes an imaging arrangement. In particular, in this way three-dimensional objects may be formed in differing sizes on the basis of available data.

Further, it may be advantageous if the lifting arrangement is formed for the purpose of raising and lowering the exposing arrangement and/or a part thereof. In particular, in this way the exposing arrangement can be moved relative to the container containing the solidifiable material, in order to manufacture the three-dimensional object.

The invention further relates to a method for manufacturing a three-dimensional object by solidifying, in particular in layers or continuously, a material that is solidifiable under the action of radiation, wherein in the method the three-dimensional object that has been solidified from the solidifiable material is held on a carrier arrangement, wherein the solidified three-dimensional object is post-solidified for the purpose of curing it, in particular by applying electromagnetic radiation thereto, wherein during post-solidification the solidified three-dimensional object is held by at least one of the carrier arrangement and a part thereof.

In particular, the three-dimensional object may be held against, on or below the carrier arrangement or a part thereof. As already described above, in this way a dimensional stability of the three-dimensional object may be maintained during post-solidification. Deformation, in particular warping, of the three-dimensional object can thus be minimised or even completely avoided. The post-solidification may be performed in particular by post-exposure, for example by applying electromagnetic radiation of suitable wavelength thereto. The post-solidification may also be performed in particular by the suitable application of heat, for example by post-polymerisation of a liquid plastics starting material that is polymerisable by applying heat or radiation.

It is favourable if a carrier arrangement having a carrier base body and at least one carrier element is provided, and before the post-solidification the carrier base body and/or the at least one carrier element are separated from the carrier arrangement, and during post-solidification the solidified three-dimensional object is held by the carrier base body and/or the at least one carrier element. In this way, deformation, in particular warping, of the three-dimensional object can be avoided during post-solidification, since a dimensional stability of the three-dimensional object can be achieved or at least supported by the carrier base body and/or the at least one carrier element.

The three-dimensional object can be post-solidified in a simple manner if before the post-solidification the carrier base body and the at least one carrier element are separated from one another, and during post-solidification the solidified three-dimensional object is held by the at least one carrier element. Thus, the three-dimensional object can be handled in a simple manner, for example can be separated from a device for manufacturing three-dimensional objects and brought to another location for the purpose of post-solidification. It is favourable if the at least one carrier element is only slightly larger than the three-dimensional object so that the at least one carrier element can be moved and handled in a simple manner.

Advantageously, the provided carrier arrangement defines a carrier surface on which the solidified three-dimensional object is held. In this way, the three-dimensional object can be solidified with a high degree of dimensional stability.

Particularly great flexibility can be achieved when the method is performed if the carrier base body and/or the at least one carrier element of the provided carrier arrangement define the carrier surface on which the solidified three-dimensional object is held. In this way, in particular, small three-dimensional objects can be manufactured on a respective carrier element and left on the respective carrier element for post-solidification. In the case of large three-dimensional objects, the carrier base body as a whole can be utilised, in which case it in turn represents a carrier element for the solidified three-dimensional object.

Depending on the type of three-dimensional object to be manufactured, it is favourable if the carrier surface is provided taking a form that is planar or, facing away from the carrier arrangement, is curved concavely or convexly. In particular, structured carrier surfaces may also be provided, having grooves, corrugations, holes, apertures or recesses of another shape.

Further, it may be advantageous if the three-dimensional object is formed using a device for manufacturing a three-dimensional object by solidifying, in particular in layers or continuously, a material that is solidifiable under the action of radiation, wherein the device includes the carrier arrangement. In this way, three-dimensional objects may be manufactured using devices of particularly compact form.

According to a further preferred variant of the method according to the invention, it may be provided for the carrier base body and the at least one carrier element to be coupled to one another before manufacture of the three-dimensional object by solidifying, in particular in layers or continuously, the material that is solidifiable under the action of radiation, and for the carrier base body and the at least one carrier element to be separated from one another before the post-solidification, wherein the three-dimensional object remains on the at least one carrier element. This proposed development in particular makes it possible to leave the solidified three-dimensional object on the at least one carrier element for post-solidification, with the result that the at least one carrier element can stabilise a shape of the three-dimensional object and deformation, for example warping, during post-solidification can be avoided.

It is favourable if the carrier base body and the at least one carrier element are coupled to one another with force locking and/or positive locking and/or by substance-to-substance bond before the three-dimensional object is manufactured by solidifying, in particular in layers or continuously, the material that is solidifiable under the action of radiation. In particular, a defined coupling of the at least one carrier element and the carrier base body ensures that there are no deviations from the desired shape of the three-dimensional object during solidifying from the solidifiable material.

Preferably, the carrier base body and the at least one carrier element are completely separated from one another before the post-solidification. In this way, the manufactured three-dimensional object can be handled in a simple manner using the at least one carrier element, for example in order to introduce it into a device for post-solidification.

It is favourable if, for the purpose of post-solidification, the solidified three-dimensional object is post-exposed by the application of UV radiation thereto. For example, in this way a plastics material that is cured or polymerised by UV radiation can be post-solidified in a simple manner.

The three-dimensional object can be post-solidified in a simple manner if it is post-solidified using a post-exposing device. For example, the post-exposing device may apply electromagnetic radiation to the three-dimensional object.

Favourably, before post-solidification the carrier base body and/or the at least one carrier element are brought or moved into engagement with the post-exposing device. This is done with the carrier base body and/or the at least one carrier element, depending on how large the three-dimensional object is.

The object stated in the introduction is further achieved by the use of one of the systems described above for manufacturing a three-dimensional object for the purpose of performing one of the methods described above for manufacturing a three-dimensional object.

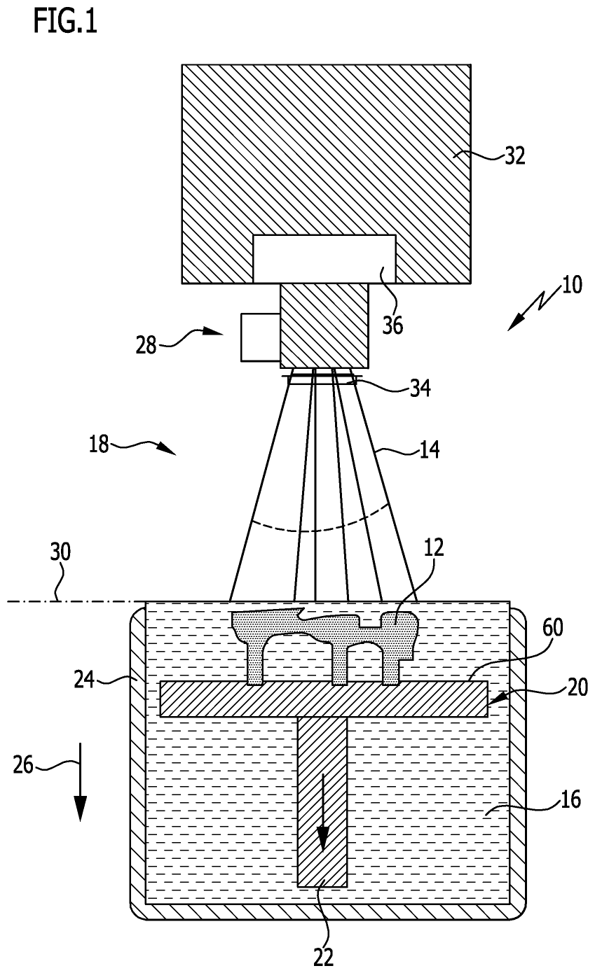

FIG. 1 illustrates schematically a system 10 for manufacturing a three-dimensional object 12 by solidifying, in particular in layers or continuously, a material 16 that is solidifiable under the action of radiation 14.

The system 10 includes in particular a device 18 for manufacturing the three-dimensional object 12 by solidifying the material 16 under the action of radiation 14. Solidification may be performed in particular in layers or continuously.

The system 10 includes a carrier arrangement 20 for holding the three-dimensional object 12 that is solidified from the solidifiable material 16.

The carrier arrangement 20 is connected to a lifting arrangement 22. In particular, it may be temporarily coupled to the lifting arrangement 22 in a coupled position.

The solidifiable material 16 is contained in a container 24. The lifting arrangement 22 is formed for the purpose of moving the carrier arrangement 20 and the container 24 relative to one another.

In particular, the lifting arrangement 22 may take a form in order to move the carrier arrangement 20 and the container 24 relative to one another in a direction parallel to the direction of gravity, defined by the arrow 26.

Further, the system 10 can include an exposing arrangement 28 for exposing the solidifiable material 16 by applying radiation 14 thereto. In particular, the solidifiable material 16 may be exposed in an image/build plane 30, onto which a layer image of a layer of defined thickness of the object 12 to be manufactured is mapped.

The exposing arrangement 28 may in particular include a radiation source 32 and an imaging arrangement 34 in order for example to image onto the image/build plane 30 a layer image that is predeterminable using an exposure mask 36.

Radiation 14 is applied to the solidifiable material 16 in the image/build plane 30 until a layer or a part of a layer of the three-dimensional object 12 has cured.

For example, the solidifiable material 16 may be manufactured in the form of a liquid polymer of plastics material, for example a polymerisable resin, that is polymerised by applying thereto electromagnetic radiation, in particular UV radiation, and is hence solidified.

Formation of the object 12 may also be performed continuously in that the carrier arrangement 20 is moved away from the image/build plane 30 continuously, and not in layers or step by step.

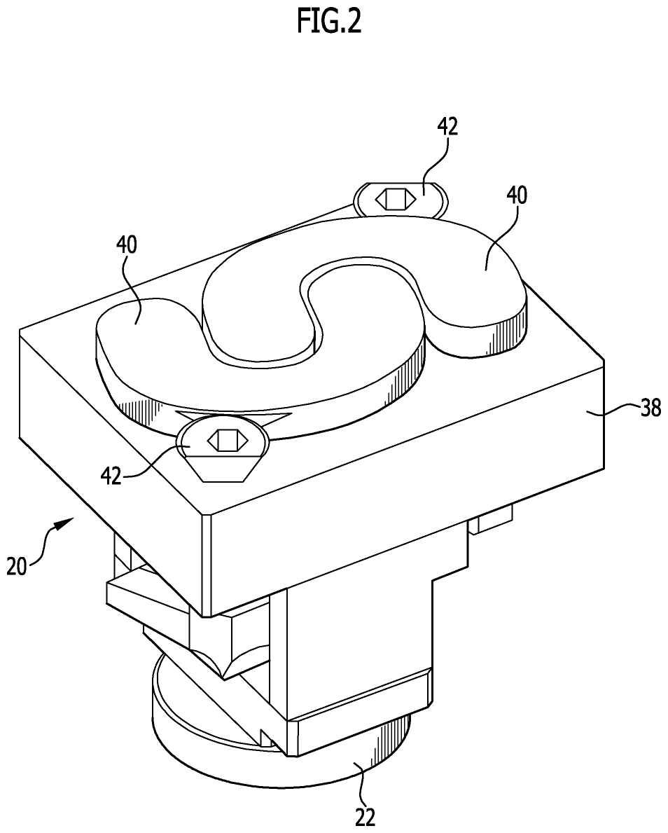

FIG. 2 is a schematic illustration of part of the system 10. The carrier arrangement 20 is connected to the lifting arrangement 22.

The carrier arrangement 20 includes a carrier base body 38 and at least one carrier element 40.

The carrier base body 38 may for example be fastened to the carrier arrangement 20 using two fastening elements 42 in the form of fastening screws. By loosening the fastening elements 42, the carrier base body 38 may as a whole be separated from the carrier arrangement 20 and hence from the device 18.

The carrier elements 40 may in principle be of any desired shape. In the exemplary embodiment illustrated in FIG. 2, the two carrier elements 40 are each in the form of flat, C-shaped plates engaging in one another.

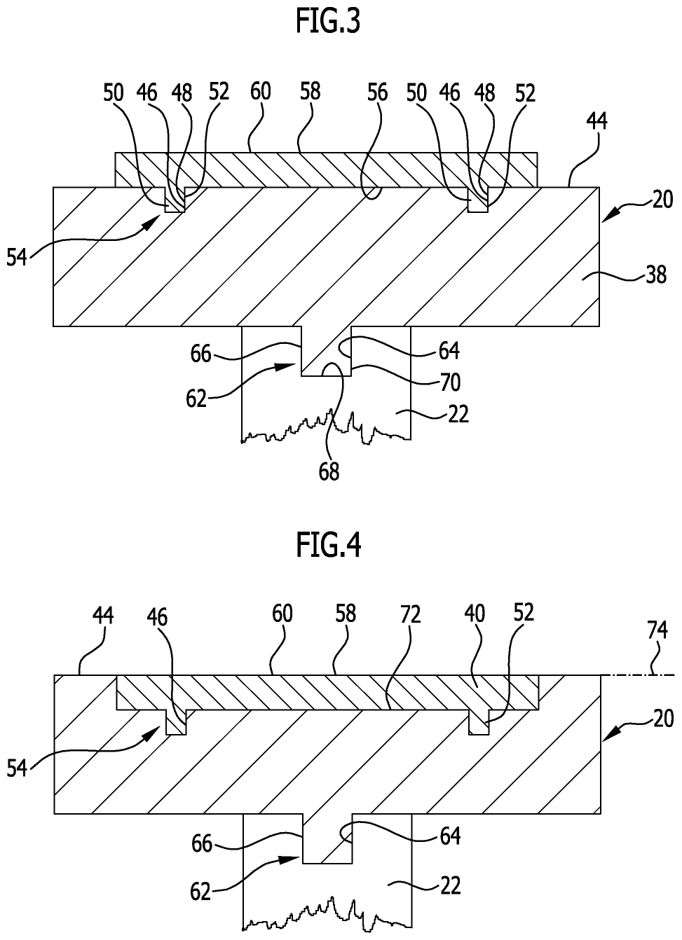

The carrier arrangement 20 is schematically illustrated in a modified form in FIG. 3. The carrier base body 38, which is in particular cuboid, defines an upper side 44 in which there are formed first coupling elements 46 in the form of coupling receivers 48. These are drawn in by way of example in FIG. 3. They serve to receive corresponding coupling projections 50 that project from an underside 56 of the carrier element 40 and form second coupling elements 52.

The mutually cooperating first and second coupling elements 46 and 52 define a coupling arrangement 54 for temporarily coupling the carrier base body 38 and the at least one carrier element 40 in a coupled position, as illustrated schematically in FIGS. 2 to 4.

By means of its underside 56, the carrier element 40 abuts flat against the upper side 44. An upper side 58 of the carrier element 40 defines a carrier surface 60, on which the solidified object 12 can be held.

The first and second coupling elements 46 and 52 take a form in particular such that in the coupled position they engage with one another with force locking and/or positive locking and/or by substance-to-substance bond.

The first and second coupling elements 46 and 52 may in particular be completely disengaged. They than adopt an uncoupled position.

Further, the system 10 can include a coupling arrangement 62 for temporarily coupling the lifting arrangement 22 and the carrier arrangement 20 in a coupled position.

The coupling arrangement 62 may include at least one first coupling element 64 and, corresponding to this, a second coupling element 66, of which one is formed or arranged on the lifting arrangement 22 and the other on the carrier arrangement 20.

In the coupled position, the first and second coupling elements 64 and 66 engage with force locking and/or positive locking and/or by substance-to-substance bond.

Optionally, as an alternative or in addition, the first and second coupling elements 46 and 52 and the first and second coupling elements 64 and 66 may also be connected to one or held together magnetically or by negative pressure.

The first coupling element 64 may in particular take the form of a coupling receiver 68. The second coupling element 66 may in particular take the form of a coupling projection 70 that corresponds to the coupling receiver.

In the coupled position, the coupling projection 70 and the coupling receiver 68 may engage with force locking and/or positive locking and/or by substance-to-substance bond.

In the exemplary embodiment of the carrier arrangement 20 that is illustrated schematically in FIG. 4, the at least one carrier element 40 forms a part of the carrier base body 38. The carrier base body 38 has a carrier element receiver 72 into which the carrier element 40 can be introduced with positive locking. In addition, the carrier element 40 and the carrier base body 38 may be coupled to one or more pairs of cooperating first and second coupling elements 42 and 52 by way of a coupling arrangement 54.

The upper side 44 of the carrier base body 38 and the upper side 58 of the carrier element 40 together form the carrier surface 60. The carrier surface 60 defines a carrier plane 74.

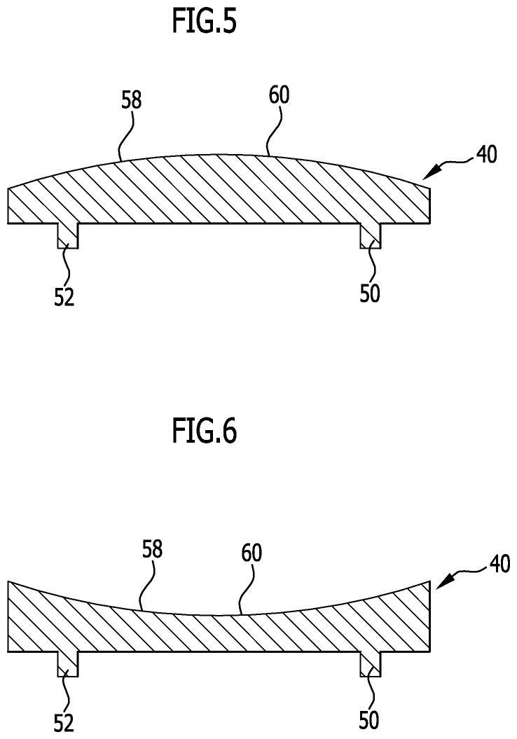

As an alternative, as illustrated schematically in FIG. 5, the carrier element 40 may have an upper side 58 that is convexly curved in a manner facing away from the carrier element 40 and may thus define a convexly curved carrier surface 60.

As an alternative, as illustrated schematically in FIG. 6, the carrier element 40 may also have an upper side 58 that is concavely curved in a manner facing away from the carrier element 40 and defines a concavely curved carrier surface 60.

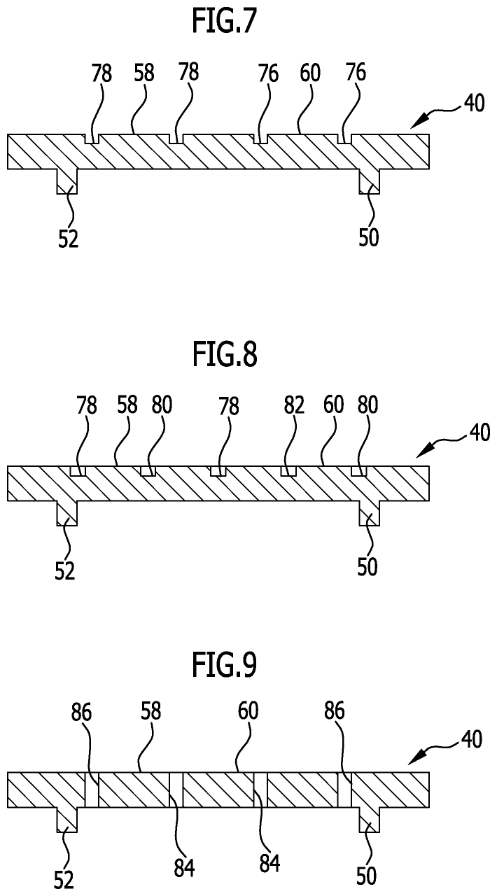

As illustrated schematically in FIG. 7, the carrier element 40 may have a structured upper side 58; this may in particular be provided with a plurality of grooves 76. The grooves 76 may take a form that is microscopic or indeed macroscopic, and have widths in the range of a few micrometres to a few millimetres.

As an alternative or in addition to the grooves 76, it is also possible for one or more recesses 78 in the form of blind holes 80 to be made in the upper side 58, as illustrated by way of example in FIG. 8.

The grooves 76 illustrated schematically in FIG. 7 likewise form recesses 78.

The recesses 78 may in particular also take the form of indentations 82 of any desired cross section parallel to the carrier surface 60, as illustrated schematically in FIG. 8.

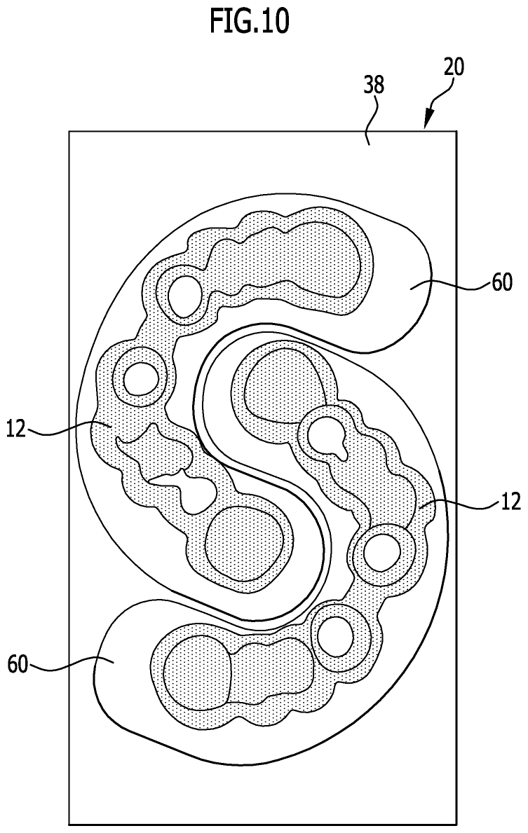

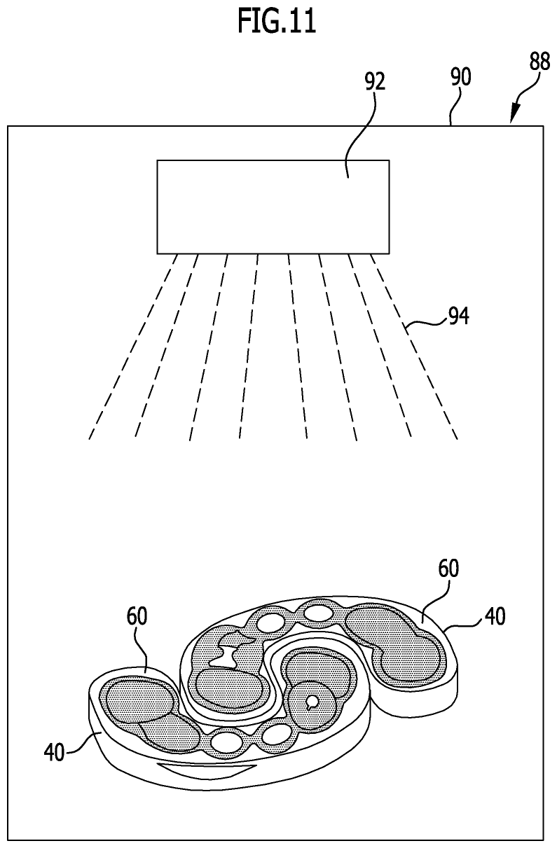

As an alternative or in addition, the carrier element 40, as illustrated by way of example in FIG. 9, may also have one or more apertures 84. In particular, these may take the form of bored holes 86.

FIG. 10 illustrates schematically a plan view of a carrier arrangement 20 having two carrier elements 40 that are coupled to the carrier base body 38. A three-dimensional solidified object 12 is held on each carrier element 40.

For the purpose of post-solidifying the objects 12, the carrier elements 40 are separated from the carrier base body 38, by disengaging the first and second coupling elements 46 and 52.

The objects 12, each held on a respective carrier element 40, can now be brought into a post-solidifying arrangement 88. This may in particular take the form of a post-exposing arrangement 90, with a radiation source 92 for generating radiation 94 for the purpose of post-solidifying the objects 12.

The radiation source 92 may in particular be formed to generate electromagnetic radiation in the ultraviolet spectral range. For example, in this way a plastics material which has not yet been fully polymerised throughout and from which the objects 12 are made can be fully polymerised throughout.

The wavelength of the radiation 94 is optionally adapted to the material 16 that is to be solidified, in order to be able to achieve optimum solidification of the objects 12 here with minimum energy input.

The post-solidifying arrangement 88 is optionally a constituent part of the system 10.

Because, during post-solidification, the objects 12 are held on the carrier elements 40, or optionally also on the carrier base body 38, the objects 12 do not deform during post-solidification as was the case hitherto, but remain dimensionally stable and do not warp, or do so markedly less than in a post-solidification in which the objects 12 are not held on a carrier element 40.

### LIST OF REFERENCE NUMERALS

10 System
12 Object
14 Radiation
16 Material
18 Device
20 Carrier arrangement
22 Lifting arrangement
24 Container
26 Arrow
28 Exposing arrangement
30 Image/build plane
32 Radiation source
34 Imaging arrangement
36 Exposure mask
38 Carrier base body
40 Carrier element
42 Fastening element
44 Upper side
46 First coupling element
48 Coupling receiver
50 Coupling projection
52 Second coupling element
54 Coupling arrangement
56 Underside
58 Upper side
60 Carrier surface
62 Coupling arrangement
64 First coupling element
66 Second coupling element
68 Coupling receiver
70 Coupling projection
72 Carrier element receiver
74 Carrier plane
76 Groove
78 Recess
80 Blind hole
82 Indentation
84 Aperture
86 Bored hole
88 Post-solidifying arrangement
90 Post-exposing arrangement
92 Radiation source
94 Radiation

What is claimed is:

1. A system for manufacturing a three-dimensional object by solidifying, in particular in layers or continuously, a material that is solidifiable under the action of radiation, wherein the system includes a device for manufacturing a three-dimensional object by solidifying, in particular in layers or continuously, a material that is solidifiable under the action of radiation, wherein the system includes a carrier arrangement for holding the three-dimensional object that has been solidified from the solidifiable material, wherein on the one hand at least one of the carrier arrangement and a part thereof, and on the other the device, are formed such that they are detachably connectable to one another, in particular for the purpose of separation once the solidified three-dimensional object has been formed.

2. The system according to claim 1, wherein
a) the carrier arrangement includes a carrier base body and at least one carrier element, and in that the carrier base body and the at least one carrier element are formed such that they are detachably connectable to one another or
b) the carrier arrangement includes a carrier base body and at least one carrier element, and in that the carrier base body and the at least one carrier element are formed such that they are detachably connectable to one another and the at least one carrier element forms part of the carrier base body.

3. The system according to claim 1, wherein the carrier arrangement defines a carrier surface on which the solidified three-dimensional object is held.

4. The system according to claim 3, wherein at least one of
a) at least one of the carrier base body and the at least one carrier element define the carrier surface and/or
b) the carrier surface takes a form that is planar or, facing away from the carrier arrangement, is curved concavely or convexly or takes a structured form and/or
c) the carrier surface has at least one recess or aperture.

5. The system according to claim 3, wherein the carrier surface has at least one recess or aperture and the at least one recess takes the form of a groove or a hole or an indentation.

6. The system according to claim 1, wherein the device includes the carrier arrangement.

7. The system according to claim 1, wherein the carrier arrangement includes a carrier base body and at least one carrier element, and in that the carrier base body and the at least one carrier element are formed such that they are detachably connectable to one another, wherein the system comprises a coupling arrangement for temporarily coupling the carrier base body and the at least one carrier element in a coupled position.

8. The system according to claim 7, wherein the coupling arrangement includes at least one first coupling element and at least one second coupling element, of which one is formed or arranged on the carrier base body and the other on the at least one carrier element, and in the coupled position engage at least one of with force locking and positive locking and by substance-to-substance bond.

9. The system according to claim 8, wherein at least one of
a) the at least one first coupling element and the at least one second coupling element are disengaged in an uncoupled position in which the carrier base body and the at least one carrier element are completely separated from one another and/or
b) the at least one first coupling element takes the form of a coupling receiver, and in that the at least one second coupling element takes the form of a coupling projection that corresponds to the coupling receiver.

10. The system according to claim 1, further comprising a container for the solidifiable material, wherein the carrier arrangement and the container are formed or arranged movable relative to one another.

11. The system according to claim 1, further comprising a lifting arrangement for moving the carrier arrangement relative to at least one of a radiation source and to the container.

12. The system according to claim 11, further comprising
a) a coupling arrangement for temporarily coupling the lifting arrangement and the carrier arrangement in a coupled position or
b) a coupling arrangement for temporarily coupling the lifting arrangement and the carrier arrangement in a coupled position, wherein the coupling arrangement includes at least one first coupling element and at least one second coupling element, of which one is formed or arranged on the lifting arrangement and the other on the carrier arrangement, and which in the coupled position engage at least one of with force locking and positive locking and by substance-to-substance bond.

13. The system according to claim 11, further comprising a coupling arrangement for temporarily coupling the lifting arrangement and the carrier arrangement in a coupled position, wherein the coupling arrangement includes at least one first coupling element and at least one second coupling element, of which one is formed or arranged on the lifting arrangement and the other on the carrier arrangement, and which in the coupled position engage at least one of with force locking and positive locking and by substance-to-substance bond, wherein at least one of
a) the at least one first coupling element and the at least one second coupling element are disengaged in an uncoupled position in which the lifting arrangement and the carrier arrangement are completely separated from one another and/or
b) the at least one first coupling element takes the form of a coupling receiver, and in that the at least one second coupling element takes the form of a coupling projection that corresponds to the coupling receiver.

14. The system according to claim 11, wherein the lifting arrangement is formed for the purpose of raising and lowering the carrier arrangement in relation to the direction of gravity.

15. The system according to claim 1, further comprising an exposing arrangement for the purpose of exposing the solidifiable material by the application of radiation thereto, in particular in layers or continuously.

16. The system according to claim 15, wherein at least one of
a) the exposing arrangement includes a radiation source and/or
b) the exposing arrangement includes an imaging arrangement and/or
c) the lifting arrangement is formed for the purpose of raising and lowering at least one of the exposing arrangement and a part thereof.

17. The system according to claim 1, wherein the at least one carrier element is in the form of a flat, C-shaped plate.

18. A method for manufacturing a three-dimensional object by solidifying, in particular in layers or continuously, a material that is solidifiable under the action of radiation, wherein in the method the three-dimensional object that has been solidified from the solidifiable material is held on a carrier arrangement, wherein the solidified three-dimensional object is post-solidified for the purpose of curing it, in particular by applying electromagnetic radiation thereto, wherein during post-solidification the solidified three-dimensional object is held by at least one of the carrier arrangement and a part thereof.

19. The method according to claim 18, wherein a carrier arrangement having a carrier base body and at least one carrier element is provided, and in that before the post-solidification at least one of the carrier base body and the at least one carrier element are separated from the carrier arrangement, and in that during post-solidification the solidified three-dimensional object is held by at least one of the carrier base body and the at least one carrier element.

20. The method according to claim 19, wherein at least one of
a) before the post-solidification the carrier base body and the at least one carrier element are separated from one another, and in that during post-solidification the solidified three-dimensional object is held by the at least one carrier element and/or
b) the provided carrier arrangement defines a carrier surface on which the solidified three-dimensional object is held and/or
c) at least one of the carrier base body and the at least one carrier element of the provided carrier arrangement define the carrier surface on which the solidified three-dimensional object is held and/or
d) the carrier base body and the at least one carrier element are coupled to one another before manufacture of the three-dimensional object by solidifying, in particular in layers or continuously, the material that is solidifiable under the action of radiation, and in that the carrier base body and the at least one carrier element are separated from one another before the post-solidification, wherein the three-dimensional object remains on the at least one carrier element and/or
e) the carrier base body and the at least one carrier element are completely separated from one another before the post-solidification.
